(19) United States
(12) Patent Application Publication
(10) Pub. No.: US 2001/0024415 A1
(43) Pub. Date: Sep. 27, 2001

(54) Integrated unit and optical pickup

(76) Inventors: Hirotoshi Takemori, Nara-shi (JP); Kazunori Matsubara, Shiki-gun (JP); Toshikazu Nagaura, Nara-shi (JP)

Correspondence Address: Dike, Bronstein, Roberts & Cushman, Intellectual Property Practice Group, EDWARDS & ANGELL, P.O. Box 9169, Boston, MA, 02209, US

(21) Appl. No.: 09/756,493

(22) Filed: Jan. 8, 2001

(30) Foreign Application Priority Data
Jan. 14, 2000 (JP) 2000-005661(P)

(51) Int. Cl. G11B 7/135

(52) U.S. Cl. 369/112.11

(57) ABSTRACT

The optical pickup according to the present invention includes an integrated unit having a laser beam source, a detecting portion, a diffraction element integrated and an objective lens. In addition, a transparent optical compensation film is provided in the optical path from laser beam source to objective lens. Integrated unit according to the present invention includes the optical compensation film.

### BACKGROUND OF THE INVENTION

1. Field of the Invention

The present invention relates to an optical pickup used in an apparatus for optically recording information into and reproducing information from an information storage medium.

2. Description of the Background Art

An optical disk for optically recording and reproducing information is capable of recording a large amount of information at high density so that it is utilized in many fields such as audio systems, video systems, and computers.

Conventionally, in order to improve the recording and reproducing characteristics of the optical pickup incorporated in the above-described optical disk, there is a need to allow more signal light to enter into an optical detector. A polarization optical system was employed to improve the signal quality.

In recent years, however, the advances of the pickup and drive technologies have enabled sufficient recording and reproducing characteristics with limited amount of light. In addition, the demand for greater compactness and lower cost is increasing. Thus, the trend is shifting toward the method employing a simpler optical system than the polarization optical system.

One representative example is an integrated unit optical system having a light source and. a light detecting portion using a diffraction element. This optical system is a very simple system formed only by an integrated unit and an objective lens. More specifically, the type having a collimator lens inserted between the objective lens and the integrated unit or the type having a raised mirror inserted between the objective lens and the integrated unit is possible.

In this optical system, a plastic element described in Japanese Patent Laying-Open No. 10-254335 or Japanese Patent Laying-Open No. 10-187014 besides the conventional glass element is used as the diffraction element. When compared with the conventional glass element, the use of such plastic element allows considerable reduction in material cost as well as in the cost required by the manufacturing method.

Recently, however, in order to achieve higher densities, as in a DVD (Digital Versatile Disk), higher NA (numerical aperture) of the objective lens as well as smaller disk thickness is being realized. A thinner disk causes the problem of increased birefringence that occurs upon disk formation so that a pickup capable of stably recording into or reproducing from a disk having a large birefringence is required.

For instance, Japanese Patent Laying-Open No. 10-83552 describes a polarization optical system in which an element capable of changing its polarization direction or a wave plate is provided with its optical axis supported rotatably so as to adjust the reflected light or the transmitted light in a polarization beam splitter to be maximum according to the birefringence of the disk. As shown in FIG. 13, a liquid crystal rotary polarization element 23 is provided between a condenser lens 5 and a quarter-wave plate 22. Here, a polarization beam splitter 24 serves to change the ratio of the amount of the transmitted light and the amount of the reflected light according to the polarization state of the light. The ratio of transmission to reflection for a horizontal polarized wave is 0:1, while the ratio of transmission to reflection for a vertical polarized wave is 1:0. The laser beam normally emitted as a horizontal polarized wave from a laser beam source 1 is turned into a parallel beam through a collimator lens 7, and enters into polarization beam splitter 24. Since it is a horizontal polarized wave, the entire light volume is reflected, passes through quarter-wave plate 22, and becomes a circularly polarized light, and thereafter enters into condenser lens, 5. The beam is focused to a light spot of about 1 μm with the condenser lens 5, and reaches the storage medium on an optical disk 9. The luminous flux that is reflected or diffracted from the disk once again goes back through condenser lens 5 and passes through quarter-wave plate 22. In the case where the birefringence of optical disk 9 is negligible, the beam that passed through quarter-wave plate 22 becomes a vertical polarized wave, and substantially all of the light volume passes through beam splitter 24 where the beam is divided equally in two directions by a prism half mirror 25. One of the divided rays passes through a detection lens 26 and enters into a quartering detector 27, and is converted into a focus signal. The other of the divided rays enters into a halving detector 28 and is converted into a tracking control signal. In the case of an optical disk medium having a large birefringence, however, the light volume for the detector is reduced and the light volume returning to the laser is increased so that the recording and reproducing operations become unstable. Thus, liquid crystal rotary polarization element 23 is operated between condenser lens 5 and quarter-wave plate 22. Liquid crystal rotary polarization element 23 is designed as a liquid crystal element in which the angle of rotation of rotary polarization in the direction of polarized wave changes from 0 degree to 90 degrees according to the amount of voltage applied to the transparent electrodes provided on both surfaces of the element. Thus, the voltage applied to liquid crystal rotary polarization element 23 can be changed according to the amount of birefringence of disk 9 into which information is recorded or from which information is reproduced so as to maximize the amount of light that is transmitted through polarization beam splitter 24 and to achieve high reliability in recording and reproducing of signals.

In addition, Japanese Patent Laying-Open No. 6-309690 describes employing a nonpolarization beam splitter that allows separation of the disk-reflected light toward a light receiving portion regardless of the magnitude of the birefringence of the disk, while at the same time, allowing the reduction of the interference noise due to the returned light from the disk with the provision of a quarter-wave plate between a beam splitter and an objective lens. As shown in FIG. 14, this light pickup is one in which a light beam from light source 1 is irradiated on optical disk 9 and the reflected light thereof is separated toward a light receiving portion 29. The reflected light is separated by a nonpolarization beam splitter 30, while at the same time, a quarter-wave plate 22 is provided between nonpolarization beam splitter 30 and optical disk 9. The reflectance of nonpolarization beam splitter 30 is between 40 to 60 percent. By using a nonpolarization beam splitter as the element for separating the reflected light toward a light receiving portion, the reflected light can be equally separated toward the light receiving portion for all types of polarization even when birefringence exists on a disk substrate, and no degradation in the reproduced signal characteristic occurs. Moreover, the provision of a quarter-wave plate between the nonpolarization beam splitter and the optical disk reduces the interference noise such that a good reproduced signal may be obtained.

Thus, it is suggested in the above literature that the effect of birefringence of the disk be alleviated and that the interference noise due to returned light be reduced by using a phase difference element or an optical compensation element that has the function of converting the polarization state (linearly polarized light, circularly polarized light, or elliptically polarized light) of a liquid crystal rotary polarization element, a wave plate, or the like. Moreover, in FIG. 14, 5 denotes an objective lens, 7 denotes a collimator lens, 31 a mirror, and 32 an expander lens.

In the optical system including the above-described integrated unit, no polarizing element is employed so that such adverse effects as a change in the amount of the signal light entering a detector do not occur even when the polarization state of the reflected light changes due to birefringence of the disk.

In practice, however, the diffraction state of an information pit formed on the disk changes due to the condition of birefringence of the disk so that the signal quality is affected. Thus, even in a nonpolarization optical system, there is a problem of the disk-reflected light (pit diffraction light) itself varying when birefringence of the disk is large. In other words, the disk-reflected light is made to vary according to the relation between the polarization direction of the disk incident beam and the direction of the optical axis of the disk birefringence.

Consequently, the nonpolarization optical system also requires optimization of the polarization state of the incident beam on the disk effected by inserting a phase difference generating element such as a wave plate within the optical system. When a wave plate or a rotary polarization element that allows rotation of the polarization direction is newly provided, however, not only do the numbers of components and of locations requiring assembly adjustment increase, but also the cost of the pickup increases since a wave plate and the like are more expensive compared with other optical components such as a regular mirror.

### SUMMARY OF THE INVENTION

The present invention is made to solve the above-described problems, and its object is to provide an integrated unit and an optical pickup that are highly reliable, yet low cost, have good mass production capacity, and are capable of accommodating large birefringence of a disk.

The integrated unit according to the present invention includes a laser beam source for emitting a laser beam, a detecting portion for detecting a reflected light, a diffraction element for diffracting the laser beam, and a casing accommodating the laser beam source and the detecting portion, and the diffraction element and the casing are integrated, while the integrated unit and an optical compensation film are integrated.

An example of the above-mentioned optical compensation film is a high polymer film subjected to stretching so as to change the polarization state of the laser beam. More specifically, the optical compensation film according to the present invention can be formed by subjecting to plastic forming such as uniaxial stretching or biaxial stretching a high polymer of polyolefin-type that is even and has little deformation. Moreover, the present optical compensation film has a prescribed birefringence distribution. The polymer member having even molecular orientation with a birefringence that is at most 10 nm is subjected to high accuracy stretching operation in the uniaxial or biaxial direction, thereby causing displacement in the molecular orientation, which results in the optical film attaining optical anisotropy. FIG. 12 shows the models of index ellipsoids before and after the stretching operation. If planar refractive index is represented by nx, ny, and the refractive index in the thickness direction is represented by nz, nx>ny≧nz would be established for the optical compensation film formed by stretching of a normal polymer film.

The above-described optical compensation film has a film thickness of about 100 μm and is capable of changing a linearly polarized light into a circularly polarized light or an elliptically polarized light.

The above-described optical compensation film may be attached onto a diffraction element. In addition, the optical compensation film may be attached to the inside of diffraction element. Moreover, the optical compensation film may be attached to a casing portion accommodating a laser beam source and a detecting portion. In addition, when the casing has an opening and a cap member for closing the opening is provided, the optical compensation film may be attached to the cap member. Furthermore, when the optical compensation film is attached to the diffraction element, the diffraction pattern of the diffraction element may be formed on the optical compensation film, or the optical compensation film may be attached onto the diffraction pattern.

According to one aspect of the present invention, the optical pickup includes a laser beam source for emitting a laser beam, a detecting portion for detecting a reflected light, a diffraction element for diffracting the laser beam, a casing accommodating the laser beam source and the detecting portion, an integrated unit in which the diffraction element and the casing are integrated, an objective lens for condensing the laser beam onto an optical disk, and an optical compensation film being integrated with the integrated unit.

According to another aspect of the present invention, the optical pickup includes a laser beam source for emitting a laser beam, a detecting portion for detecting a reflected light, a diffraction element for diffracting the laser beam, a casing accommodating the laser beam source and the detecting portion, an integrated unit in which the diffraction element and the casing are integrated, an objective lens for condensing the laser beam onto an optical disk, a reflection mirror for changing the direction of the laser beam, and an optical compensation film being integrated with the reflection mirror.

In either of the above-described cases, the polarization state of the laser beam can be changed as described above, while at the same time an increase in the number of components can be prevented and the adjustment upon assembly becomes unnecessary.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram of an arrangement of an optical pickup according to a first embodiment.

FIG. 2 is a cross sectional view of an integrated unit according to a second embodiment.

FIGS. 3A to 3F are cross sectional views showing first to sixth steps of a manufacturing process of a diffraction element according to a third embodiment.

FIGS. 4A and 4B, 5A and 5B, and 6A and 6B are cross sectional views respectively showing first and second steps of the respective manufacturing processes of a diffraction element according to fourth, fifth, and sixth embodiments.

FIG. 7A is a plan view showing an example of a form of an optical compensation film according to a seventh embodiment, and FIG. 7B is a cross sectional view taken along the line A-A in FIG. 7A.

FIG. 8 is a cross sectional view of an integrated unit of an optical pickup according to an eighth embodiment.

FIG. 9A is a plan view showing an example of a form of an optical compensation film according to a ninth embodiment, and FIG. 9B is a cross sectional view taken along the line A-A in FIG. 9A.

FIG. 10 is a cross sectional view of an integrated unit of an optical pickup according to a tenth embodiment.

FIG. 11 is a schematic diagram of an arrangement of an optical pickup according to an eleventh embodiment.

FIG. 12 is a diagram relating to the description of the characteristics of an optical compensation film.

FIGS. 13 and 14 are diagrams relating to the description of a conventional optical pickup.

### DESCRIPTION OF THE PREFERRED EMBODIMENTS

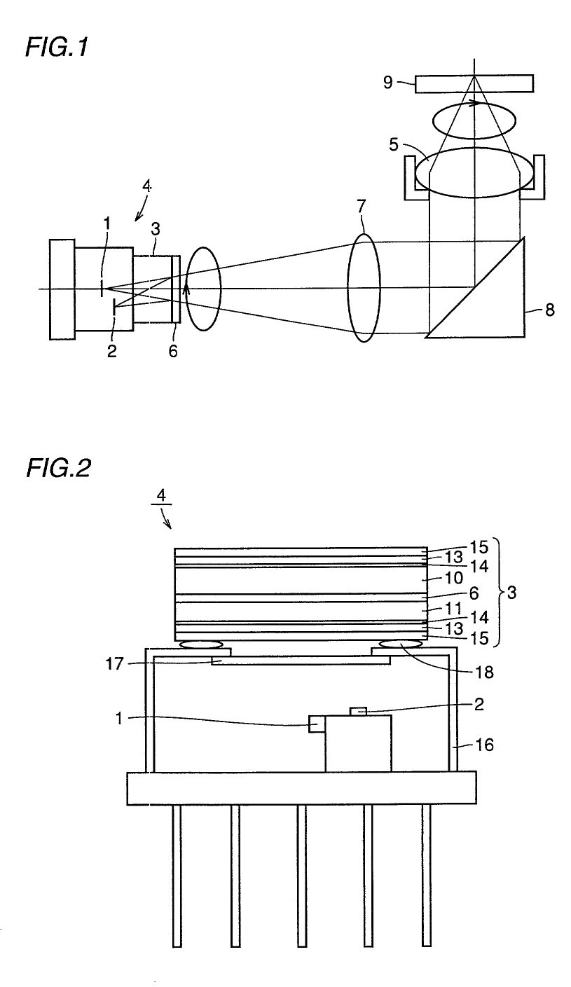

The embodiments of the present invention will be described below with reference to FIGS. 1 to 12.

First Embodiment

FIG. 1 is a schematic diagram of an arrangement of an optical pickup according to the first embodiment of the present invention. As shown in FIG. 1, the optical pickup according to the present invention includes a laser beam source 1, a detecting portion 2, a diffraction element 3, an optical compensation film 6, a collimator lens 7, a reflection mirror 8, and an objective lens 5.

Laser beam source 1 emits a laser beam. Detecting portion 2 detects the reflected light. Diffraction element 3 diffracts the laser beam. Laser beam source 1, detecting portion 2, and diffraction element 3 are integrated and thus form an integrated unit 4.

Objective lens 5 condenses the laser beam to an optical disk 9. Although FIG. 1 shows collimator lens 7 and reflection mirror 8 being provided, these components can be omitted.

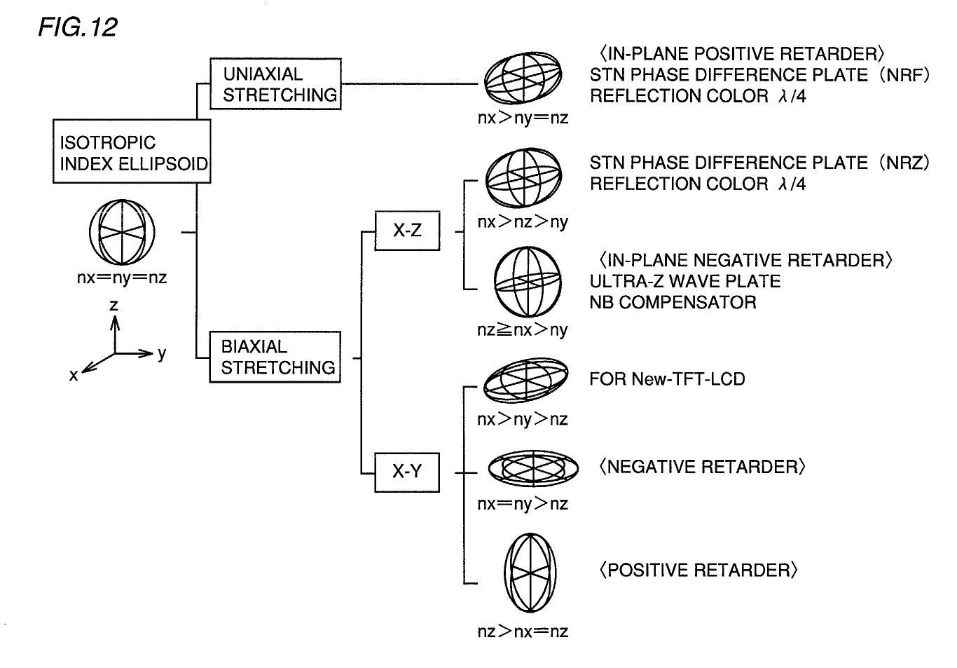

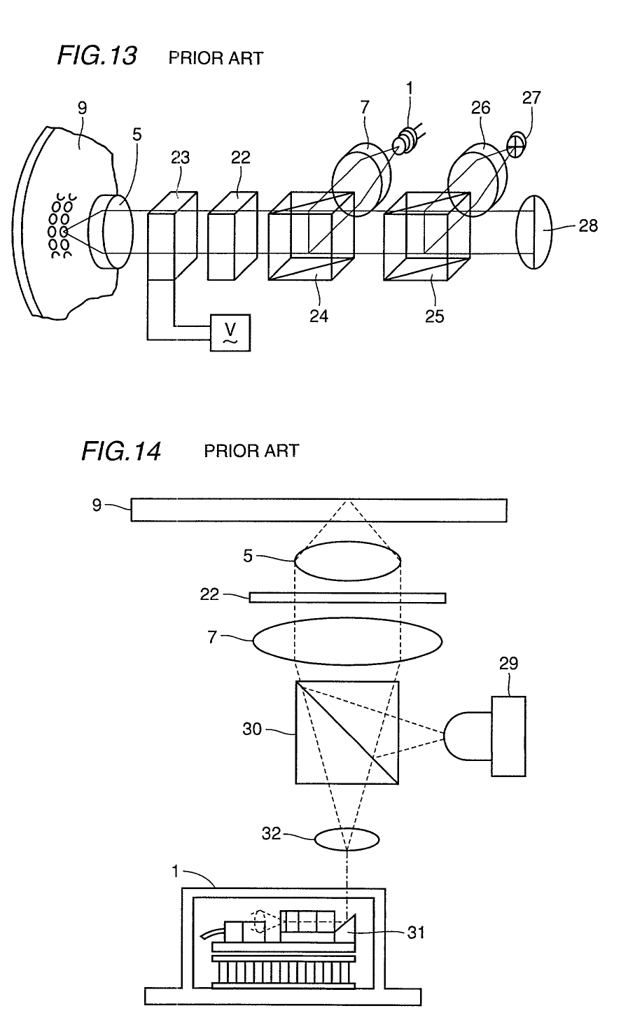

An important characteristic of the present invention is that a transparent optical compensation film 6 is placed in the optical path from laser beam source 1 to objective lens 5. Optical compensation film 6 can be utilized to improve the contrast of and to reduce or prevent color change of a liquid crystal panel. A uniaxially-stretched or biaxially-stretched plastic film can be used as optical compensation film 6. In this manner, when a plastic film is oriented by stretching, the plastic film achieves optical anisotropy so that such stretching operation causes the film index ellipsoid to change into a different type after the stretching as shown in FIG. 12.

For instance, ARTON (product name) produced by JSR Corporation can be used as optical compensation film 6. ARTON is a polyolefin-type material which has lower dependency of wavelength of birefringence than other materials such as polycarbonate or polyacrylate and has a transmittance that is as high as glass. In addition, ARTON has a water absorption rate of 0.4%, a high glass transition point temperature of 171° C., and an excellent resistance to weathering. Optical compensation film 6 serves the same function as a phase difference film, a polarization film, or the like.

The laser beam is here a linearly polarized light, but can be converted into a circularly polarized light through optical compensation film 6. In this case, there is a need to effect optimal adjustment in the polarization direction of the laser beam and in the stretching direction of the optical compensation film 6. The laser beam, however, need not be made into a perfect circularly polarized light but can be converted into an elliptically polarized light.

Now, the read operation of information in the optical pickup shown in FIG. 1 will be described. The laser beam emitted from laser beam source 1 is transmitted through diffraction element 3 and optical compensation film 6 and thus converted into a circularly polarized light or an elliptically polarized light. Then, the laser beam is transmitted through collimator lens 7 and is reflected by reflection mirror 8 and thereafter reaches objective lens 5. When the laser beam passes through objective lens 5, the laser beam is condensed and reaches the signal surface of optical disk 9.

The laser beam that is reflected back on the signal surface of optical disk 9 once again becomes a parallel luminous flux via objective lens 5, and is reflected by reflection mirror 8, and thereafter, is transmitted through collimator lens 7. Then, the laser beam is transmitted through optical compensation film 6 and diffraction element 3 and is emitted to detecting portion 2. Thus, the information recorded on optical disk 9 can be read.

Moreover, although the above-described optical compensation film 6 may be used independently in the optical path from laser beam source 1 to objective lens 5, it is preferable to use optical compensation film 6 by attaching it to some other optical component. In this embodiment, for instance, optical compensation film 6 is provided to diffraction element 3 on the objective lens side.

As described above, by attaching optical compensation film 6 to some other optical component, increase in the number of components can be avoided, and a lower cost optical pickup can be realized.

In addition, the region for transmission of the laser beam is preferably small so as to limit the negative effect of the uneven surface of optical compensation film 6 as much as possible and to keep the wave front aberration small. Thus, the wave front aberration can be kept small by using optical compensation film 6 within integrated unit 4.

In the attempt to confirm the effect of the present invention, an RF (radio frequency) signal measurement was performed using a commercially available DVD-ROM disk. When optical compensation film 6 was inserted in the optical path, asymmetry improved from 10.6% to 6.0%, while jitter improved from 11.2% to 8.8%.

Second Embodiment

Now, the second embodiment of the present invention will be described using FIG. 2. FIG. 2 is a cross sectional view of an integrated unit 4 used in the optical pickup according to the second embodiment.

As shown in FIG. 2, integrated unit 4 includes a diffraction element 3 fixed to the main body of a laser with an ultraviolet-cured type adhesive 18.

Diffraction element 3 has an optical compensation film 6 inside. A transparent substrate 10 is disposed on optical compensation film 6, and a transparent substrate 11 is disposed underneath optical compensation film 6. In other words, optical compensation film 6 is held between transparent substrates 10 and 11.

An ultraviolet-cured type polymer member 13 is formed on a surface of transparent substrate 10 with a primer treated layer 14 provided therebetween, and an antireflection layer 15 is formed on polymer member 13. Similarly, primer treated layer 14, ultraviolet-cured type polymer member 13, and antireflection layer 15 are formed on the rear surface of transparent substrate 11.

Diffraction element 3 having the above-described structure is adhered to a seal cap (casing) 16 with ultraviolet-cured type adhesive 18. A cap glass 17 is attached to close the opening of seal cap 16. In addition, a laser beam source 1 and a detecting portion 2 are accommodated within seal cap 16.

As described above, by attaching optical compensation film 6 to diffraction element 3 and thereby integrating the two, the increase in the number of components can be prevented, while assembly adjustment becomes unnecessary.

Moreover, although the second embodiment describes the case in which optical compensation film 6 is provided within diffraction element 3, optical compensation film 6 may be attached to the top surface of diffraction element 3 as shown in FIG. 1 or to the rear surface of diffraction element 3.

Like the first embodiment, improvements in asymmetry and jitter were found when the RF signal measurement was performed with a similar DVD-ROM disk using a similar optical compensation film 6 in the same optical system as that of the first embodiment.

Third Embodiment

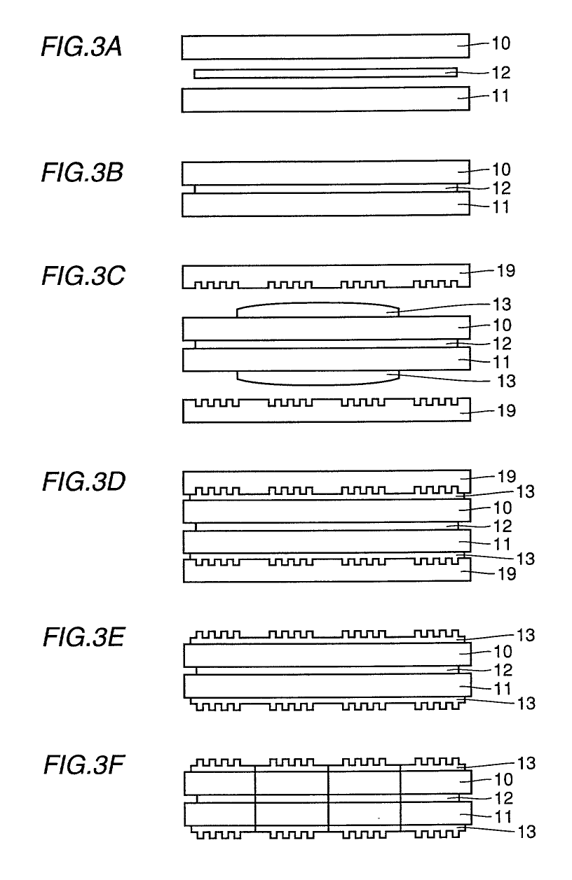

Now, a method of manufacturing a diffraction element 3, particularly in the case where an optical compensation film 6 is inserted in diffraction element 3, will be described with reference to FIG. 3. FIGS. 3A to 3F are cross sectional views showing first to sixth steps of the manufacturing process of diffraction element 3 according to the third embodiment.

First, as shown in FIG. 3A, an optical compensation film sheet 12 is disposed between transparent substrates 10 and 11. Then, as shown in FIG. 3B, optical compensation film sheet 12 is attached to transparent substrates 10 and 11.

Then, ultraviolet-cured type polymer members 13 are applied on the top surface of transparent substrate 10 and on the rear surface of transparent substrate 11. Pressure is applied from above and from below to ultraviolet-cured type polymer members 13 using stampers (masters) 19. Thus, as shown in FIG. 3D, ultraviolet-cured type polymer members 13 are formed according to the shape of the surfaces of stampers 19.

Ultraviolet-cured type polymer members 13 are then cured, and stampers 19 are taken away from ultraviolet-cured type polymer members 13. In this way, as shown in FIG. 3E, diffraction patterns can be formed by ultraviolet-cured type polymer members 13 on the surface of transparent substrate 10 and on the rear surface of transparent substrate 11.

Thereafter, as shown in FIG. 3F, the stacked body formed of transparent substrates 10 and 11, optical compensation film sheet 12, and ultraviolet-cured type polymer members 13 is divided into a plurality of parts. In this manner, a diffraction element 3 is formed. Diffraction element 3 is fixed to the main body of a laser.

Moreover, transparent substrates 10 and 11 used in this embodiment each have a thickness of 1 mm which is half the thickness of a normal substrate.

Fourth Embodiment

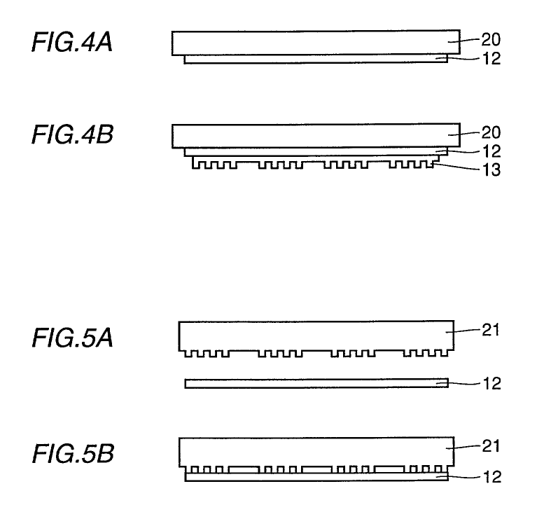

Now, the fourth embodiment of the present invention will be described with reference to FIG. 4. FIGS. 4A and 4B are cross sectional views showing first and second steps of the manufacturing process of a diffraction element 3 according to the fourth embodiment of the present invention.

As shown in FIG. 4A, an optical compensation film sheet 12 is attached to transparent substrate 20, and then, by a similar technique to one described in the third embodiment, a diffraction pattern is formed on this optical compensation film sheet 12 using ultraviolet-cured type polymer member 13 as shown in FIG. 4B.

In this embodiment, after the formation of ultraviolet-cured type polymer member 13, the stacked body formed of transparent substrate 20, optical compensation film sheet 12, and ultraviolet-cured type polymer member 13 is divided into a plurality of parts to form diffraction elements 3. The following steps are the same as those in the third embodiment.

Fifth Embodiment

Now, the fifth embodiment of the present invention will be described with reference to FIG. 5. FIGS. 5A and 5B are cross sectional views showing first and second steps of the manufacturing process of a diffraction element 3 according to the fifth embodiment of the present invention.

The fifth embodiment indicates the steps of manufacturing a glass diffraction element 3. First, as shown in FIG. 5A, a diffraction pattern is formed on a surface of a glass substrate 21 using the photolithography technique (application of photosensitive material, contact exposure, development, etching, and ashing).

An optical compensation film sheet 12 is attached on the above-described diffraction pattern, as shown in FIG. 5B. Then, glass substrate 21 and optical compensation film sheet 12 are divided into a plurality of parts to form diffraction elements 3. The following steps are the same as those in the third embodiment. According to this embodiment, the present invention can be applied to diffraction element 3 made of glass.

Sixth Embodiment

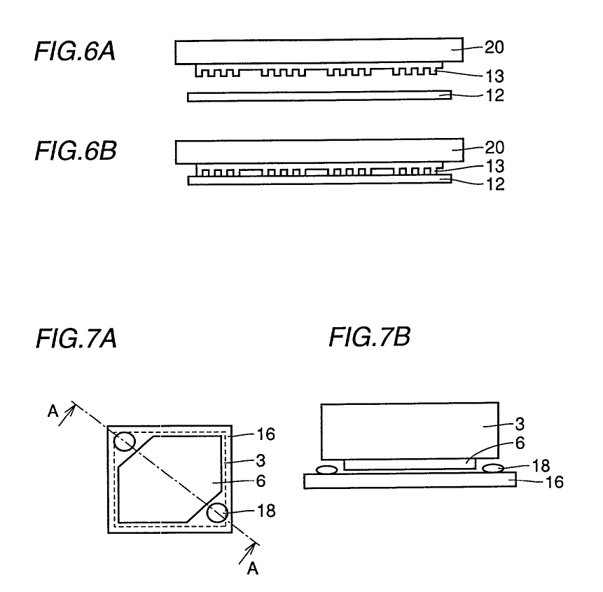

Now, the sixth embodiment of the present invention will be described with reference to FIG. 6. FIGS. 6A and 6B are cross sectional views showing first and second steps of the manufacturing process of a diffraction element 3 according to the sixth embodiment of the present invention.

As shown in FIG. 6A, a diffraction pattern is formed on a surface of a transparent substrate 20 using an ultraviolet-cured type polymer member 13. This diffraction pattern can be formed in the same method as that used in the third embodiment.

Then, as shown in FIG. 6B, an optical compensation film sheet 12 is attached onto ultraviolet-cured type polymer member 13. Thereafter, the stacked structure shown in FIG. 6B is divided into parts as in the case of the third embodiment to form a diffraction element 3, and this diffraction element 3 is fixed to the main body of a laser.

Seventh Embodiment

Now, the seventh embodiment of the present invention will be described with reference to FIG. 7. FIGS. 7A and 7B are diagrams related to the description of the method of fixing a diffraction element 3 to a main body of a laser according to the seventh embodiment of the present invention.

Diffraction element 3 is fixed to the main body of a laser, for instance, by an ultraviolet-cured type adhesive 18. At this time, an optical compensation film 6 is worked so as to give it a shape that does not overlap with the locations of adhesion between diffraction element 3 and the main body of the laser. Specifically, a pair of corners of optical compensation film 6 that are located diagonally are cut away. Thus, diffraction element 3 and the main body of the laser can be fixed very securely to one another. In addition, one of diffraction element 3 and the main body of the laser can press optical compensation film 6 against the other, thereby improving the adhesive property of optical compensation film 6.

Eighth Embodiment

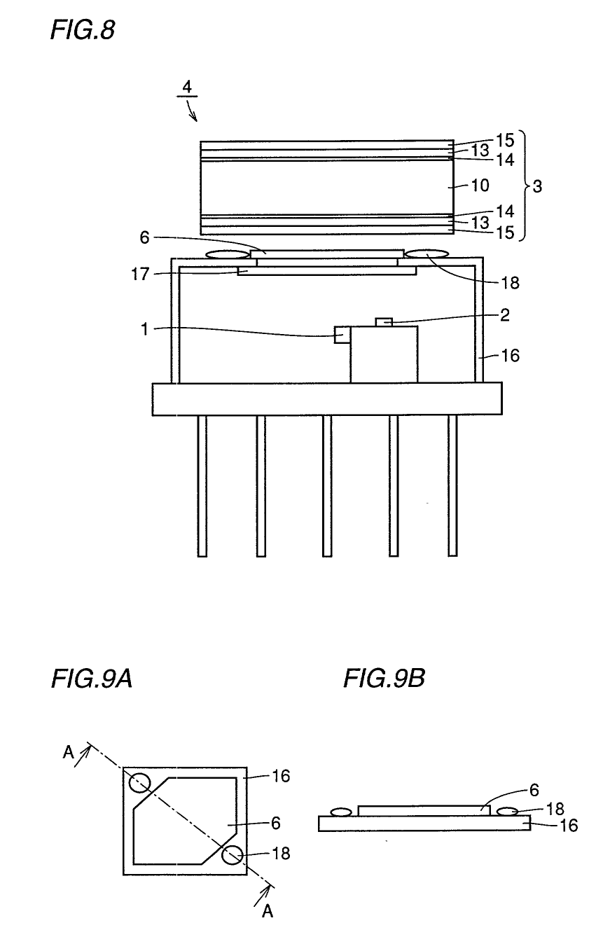

Now, the eighth embodiment of the present invention will be described with reference to FIG. 8. FIG. 8 is a cross sectional view of an integrated unit 4 according to the eighth embodiment of the present invention.

In the eighth embodiment, an optical compensation film 6 is attached to a seal cap 16. Other parts of the structure are the same as those in the second embodiment so that the descriptions thereof will not be repeated.

Like the first embodiment, improvements in asymmetry and jitter were found when the RF signal measurement similar to that of the first embodiment was performed using integrated unit 4 according to the eighth embodiment.

Ninth Embodiment

Now, the ninth embodiment of the present invention will be described with reference to FIG. 9. FIGS. 9A and 9B are diagrams an example of the form of an optical compensation film 6 in the case where optical compensation film 6 is attached to the laser main body side.

As shown in FIGS. 9A and 9B, optical compensation film 6 has corners cut away so as to avoid the locations of application of ultraviolet-cured type adhesive 18. In this embodiment, the same effect as the seventh embodiment can be expected.

Tenth Embodiment

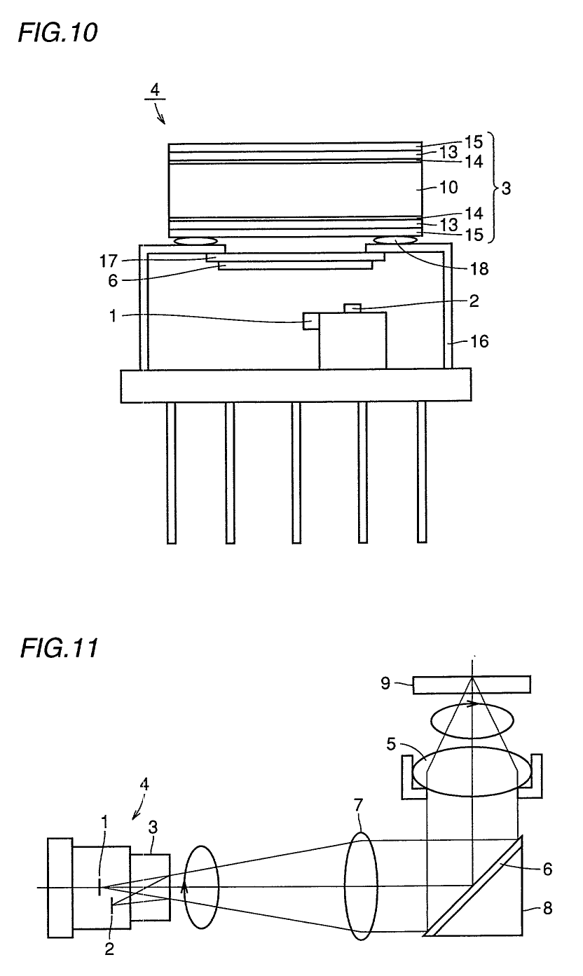

Now, the tenth embodiment of the present invention will be described with reference to FIG. 10. FIG. 10 is a cross sectional view of an integrated unit 4 according to the tenth embodiment of the present invention.

In the tenth embodiment as shown in FIG. 10, an optical compensation film 6 is attached to a cap glass 17 that closes the opening of a seal cap 16. Other parts of the structure are the same as those in the second embodiment.

Like the first embodiment, improvements in asymmetry and jitter were observed when the RF signal measurement similar to that of the first embodiment was performed using an optical pickup incorporating integrated unit 4 according to the tenth embodiment.

Eleventh Embodiment

Now, the eleventh embodiment of the present invention will be described with reference to FIG. 11. FIG. 11 is a schematic diagram of an arrangement of an optical pickup according to the eleventh embodiment of the present invention.

In the eleventh embodiment, an optical compensation film 6 is attached to a reflection mirror 8. Other parts of the structure are the same as those in the first embodiment.

Like the first embodiment, improvements in asymmetry and jitter were observed when the RF signal measurement similar to that of the first embodiment was performed with respect to the optical pickup according to the eleventh embodiment.

With the integrated unit and the optical pickup according to the present invention, as described above, the polarization direction of the laser beam can be desirably changed owing to the transparent optical compensation film provided in the optical path from the light source to the objective lens. In this way, the optimal reflected light can be obtained even with a disk having a large birefringence, and stable recording and reproducing operations become possible. Moreover, the optical compensation film according to the present invention can be formed, for instance, by subjecting a high polymer film to a prescribed stretching operation so that it allows production at a low cost. As a result, a low cost integrated unit or optical pickup is realized. Furthermore, since optical compensation film need only be attached to the integrated unit or a reflection mirror, the provision or the adjustment of the optical components such as a wave plate is not required. Thus, the increase in the number of optical components can be prevented, and elimination of an adjustment step of the optical components leads to lower cost. In addition, the integrated unit and the optical pickup can be made more compact.

Thus, the present invention provides an integrated unit and an optical pickup that are compact, low cost, and highly reliable, have good mass production capacity, and allow stable recording and reproducing operations even with a disk having large birefringence.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An integrated unit, comprising:
a laser beam source for emitting a laser beam;
a detecting portion for detecting a reflected light;
a diffraction element for diffracting the laser beam; and
a casing accommodating said laser beam source and said detecting portion, wherein said integrated unit and a transparent optical compensation film are integrated in said integrated unit in which said diffraction element and said casing are integrated.

2. The integrated unit according to claim 1, wherein
said optical compensation film is a high polymer film serving a function of changing polarization state of the laser beam.

3. The integrated unit according to claim 1, wherein
said optical compensation film is attached onto said diffraction element.

4. The integrated unit according to claim 1, including said optical compensation film inside of said diffraction element.

5. The integrated unit according to claim 1, wherein said casing and said optical compensation film are integrated.

6. The integrated unit according to claim 1, including a cap member, provided to said casing, for closing an opening.

7. The integrated unit according to claim 6, wherein said cap member and an optical compensation film are integrated.

8. The integrated unit according to claim 3, wherein
said diffraction element has a diffraction pattern for diffracting a laser beam, said diffraction pattern being formed on said optical compensation film.

9. The integrated unit according to claim 3, wherein
said diffraction element has a diffraction pattern for diffracting a laser beam, said optical compensation film being formed on said diffraction pattern.

10. An optical pickup for reading information recorded on an optical disk by condensing a laser beam onto the optical disk, comprising:
a laser beam source for emitting a laser beam;
a detecting portion for detecting a reflected light;
a diffraction element for diffracting the laser beam;
a casing accommodating said laser beam source and said detecting portion;
an integrated unit in which said diffraction element and said casing are integrated; and
an objective lens for condensing the laser beam onto the optical disk, wherein
said integrated unit and a transparent optical compensation film are integrated.

11. An optical pickup for reading information recorded on an optical disk by condensing a laser beam onto the optical disk, comprising:
a laser beam source for emitting a laser beam;
a detecting portion for detecting a reflected light;
a diffraction element for diffracting the laser beam;
a casing accommodating said laser beam source and said detecting portion;
an integrated unit in which said diffraction element and said casing are integrated;
an objective lens for condensing the laser beam onto the optical disk; and
a reflection mirror for changing a direction of the laser beam, wherein
said reflection mirror and a transparent optical compensation film are integrated.
